(19) United States
(12) Patent Application Publication
(10) Pub. No.: US 2014/0100834 A1
(43) Pub. Date: Apr. 10, 2014

(54) COMPUTATIONAL METHODS FOR ANALYSIS AND MOLECULAR DESIGN OF ANTIBODIES, ANTIBODY HUMANIZATION, AND EPITOPE MAPPING COUPLED TO A USER-INTERACTIVE WEB BROWSER WITH EMBEDDED THREE- DIMENSIONAL RENDERING

(71) Applicant: Macromoltek, Austin, TX (US)

(72) Inventors: Monica Berrondo, Austin, TX (US); Susana Kaufmann, Austin, TX (US); Manuel Berrondo, Orem, UT (US)

(73) Assignee: MACROMOLTEK, Austin, TX (US)

(21) Appl. No.: 14/045,928

(22) Filed: Oct. 4, 2013

Related U.S. Application Data
(60) Provisional application No. 61/709,640, filed on Oct. 4, 2012.

(51) Int. Cl. G06F 19/16

(52) U.S. Cl. CPC G06F 19/16
USPC 703/11

(57) ABSTRACT

This disclosure relates in general to the field of antibody modeling and analysis. The disclosed subject matter describes a single online workspace to model and analyze antibody sequences or structures. Modeling and analysis may be performed by employing a number of features including, but not limited to, sequence analysis, structure analysis, antibody modeling, packing, antibody humanization, mutations, design, loop modeling, protein-protein docking, and scoring.

### CROSS-REFERENCE TO RELATED APPLICATIONS

This applications claims priority to U.S. Provisional Patent Application Ser. No. 61/709,640, filed Oct. 4, 2012, which is hereby incorporated by reference in its entirety.

### FIELD OF THE INVENTION

This disclosure relates in general to the field of antibody modeling and analysis, more particularly a single online workspace to model and analyze antibody sequences or structures.

### BACKGROUND OF THE INVENTION

The approaches and technological schemes described in this section could be pursued, but are not necessarily approaches that have been previously conceived or pursued. Therefore, unless specifically indicated herein, the approaches and technological schemes described in this and subsequent sections are not admitted to be prior art by inclusion in this application.

Among other mechanisms, antibodies prevent and inhibit infectious diseases by binding to proteins on the surface of undesired organisms. For example, antibodies may intercept a virus before it attaches to a targeted cell by the recognition of sites on the virus' envelope protein. Antibodies may also inhibit disease progression by altering interactions critical to the disease mechanism. Understanding the details of these binding interactions between the antibody and the foreign protein (antigen) may provide clues towards the creation of better and more specific treatments. Synthetic and engineered antibodies are used extensively as therapeutic agents in treating cancer, infectious diseases, and autoimmune disease.

The amino acids on the surface of the antigen recognized by an antibody are known as epitopes. Delineating the specifics of the antibody-antigen interaction is known as epitope mapping and is an essential step in developing new biologic therapeutics. The epitopes may consist of a linear sequence of amino acids on the antigen or a three-dimensional surface involving amino acids separated in the primary sequence but in close proximity in the antigens' folded structure.

One of the key components of understanding antibodies and their interactions lies in the analysis of the amino acid sequence. Many standalone tools and software applications exist that can compare the similarities between sequences. However, few of these software applications have been incorporated into packages for further analysis and modeling of the given sequence.

While the vast set of x-ray crystal structures of antibodies and the observations derived from those structures greatly aids the process of building antibody homology models, generating accurate models is complicated by the variability of the loop structures of the complementarity determining regions (CDRs). De novo loop modeling is an extremely active area of protein structure research, consisting of solving for the configuration of the atoms between two pieces of well-defined secondary structure. Traditionally, some of the time-honored loop modeling techniques have been applied to antibody modeling. The best methods are able to predict 4, 5, 8, and 11-12 residue loops to ˜0.5, ˜1, and ˜3 A rmsd, respectively. A canonical paradigm for predicting five of the six antibody CDR loops using a strict set of rules for classification has been established, making it possible to avoid the expensive process of de novo loop modeling on these five loops. Instead, these five loops can be grafted and refined by searching for homologous, similarly classified loops. Generating accurate three dimensional structures of an antibody of interest from its amino acid sequence can be broken down into a four-step process: (1) finding an accurate sequence alignment between the antibody to be modeled and the sequence(s) of template x-ray crystal structure(s) to assemble the β-barrel scaffold; (2) grafting the five non-hypervariable CDR loops; (3) explicitly modeling the sixth, hypervariable, H3 loop; and (4) global optimization of the scaffold and loops.

Epitope mapping is a key element in the development of vaccines, biologic therapeutics, a wide array of biosensors, and other basic immunological tools. In clinical and basic research of ailments, such as cancer or autoimmune and infectious diseases, antibodies and their associated epitopes play a key role in diagnosis, prognosis, treatment, and elucidation of disease mechanisms. For example, detection of host-derived antibodies to specific mutant p53 proteins is a promising tool for the early diagnosis of various tumors. Many other similar biomarkers exist and epitope mapping is crucial for recognizing the key antigenic determinants, which are often no more than a minor structural change resulting from a single-nucleotide polymorphism. In addition, maps of the epitope regions of antigens that elicit strong and productive immune responses can be used to develop preventative vaccines through rational design and/or targeted screens.

Structural information regarding the antigenic epitopes that antibodies recognize, coupled with sophisticated computational techniques, makes it possible to increase antibody-antigen binding affinities or to deduce the structural origin of such affinity maturation. The most precise map that can be made of an epitope is a description of the atomic interactions between the antibody and antigen in complex. As such, the present standard for epitope mapping is crystallographic determination of antibody-antigen complexes. However, x-ray crystallography turns out to be costly, time-consuming, and demanding with no guarantee of success for a given antibody-antigen complex. Hence a variety of other experimental techniques have been developed for epitope mapping.

Binding assays have been created employing mutated antibodies and/or antigens and antibodies with synthetic peptides or antigen fragments. These binding assays have been extensively used for epitope mapping but suffer from significant rates of both false negatives and false positives for identifying key residues.

Combinatorial methods, such as phage display and antigen array technologies have also been used extensively in epitope mapping. While these technologies are of great utility, it is often difficult to correlate recovered sequences with the native epitopes, particularly for non-continuous epitopes. The limitations and difficulties of experimental techniques make it highly desirable to produce a purely computational procedure that can generate atomically accurate antibody-antigen complexes.

A number of computational approaches have already been developed for epitope mapping. They range from bioinformatics approaches aimed primarily at predicting linear epitopes, to structure based modeling methods capable of dealing with the additional complexity of conformational epitopes. Recent analysis has shown that the reliability of many current bioinformatics methods is not significantly better than experimental methods and that many current models are typically able to identify only less than half of the residues in a given epitope.

An antibody's uniquely high affinity and specificity allows it to recognize and effectively neutralize antigens responsible for disease. However, most monoclonal antibodies are developed in non-human immune systems, such as mice, rabbits, pigs, and other mammals. Direct administration of these non-human antibodies into a human subject can induce an inflammatory immune response against the antibodies that not only significantly reduces its efficacy, but also poses a substantial health risk.

In the process known as ‘humanization,’ non-human antibodies with therapeutic potential are re-engineered as human-like antibodies that avoid eliciting adverse immune responses while maintaining therapeutic efficacy. The antibody humanization process typically involves insertion of the relevant CDR of the non-human antibody into a human antibody scaffold, commonly referred to as CDR grafting.

Although CDR grafting has been successful in some cases, most CDR-grafted antibodies do not retain the antigen-binding affinity of the original non-human antibody. Transferring key framework residues along with the CDRs has been shown to lead to humanized antibodies with higher antigen-binding affinity. Currently, humanizing an antibody while maintaining its therapeutic efficacy is a laborious process of trial and error that requires both specialized knowledge and expensive iterative rounds of antibody design, expression, purification, and testing. The approach to humanization involves many iterations of costly and time-consuming experiments.

While some groups have created computational approaches to humanization, they still involve many non-automated steps before reaching a final humanized sequence. A fully automated computational approach helps to decrease the number of iterations, thereby reducing the cost of discovery. In particular, the identification of suitable human antibody scaffolds, the grafting of CDR loops, and the selection and design of point mutations that stabilize the desired CDR loop conformations are key challenges in the humanization process and are well suited for a computational approach.

### BRIEF SUMMARY OF THE INVENTION

The present disclosure relates to a comprehensive design that is intended to incorporate features of molecular modeling, bioinformatics, and antibody analysis into a single online workspace for antibody modeling and analysis. The disclosed workspace may allow for a user to upload an antibody sequence or structure of their choosing into a personal workspace that can be stored in an online database. From the user's workspace, they may select to perform one of the many functions described below.

In one embodiment, the disclosed comprehensive design may incorporate multiple functioning pieces including, but not limited to, the following: sequence analysis, structure analysis, antibody modeling, packing, antibody humanization, mutations, design, loop modeling, protein-protein docking, and scoring.

The various functions of the disclosed invention use both well-known and original algorithms for the analysis and modeling of user uploaded sequences. The various functions will allow the user to modify, generate data, and analyze the behavior of antibodies in one centralized workspace.

The disclosed invention will allow users to upload sequences that can then be analyzed to identify the sequences with known structures in a database, modify a structure, assemble a model, humanize a non-human sequence, predict the stability and functional changes of a protein upon mutation, and calculate the interactions of the atoms with each other and their environment. These are just some of the many functions that users of the disclosed online workspace can utilize.

These and other aspects of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGURES and detailed description. It is intended that all such additional systems, methods, features and advantages that are included within this description, be within the scope of any claims.

### BRIEF DESCRIPTION OF THE DRAWINGS

The novel features believed characteristic of the invention will be set forth in any claims that are filed later. The invention itself, however, as well as a preferred mode of use, further objectives, and advantages thereof, will best be understood by reference to the following detailed description of an illustrative embodiment when read in conjunction with the accompanying drawings, wherein:

FIG. 1 shows an image of a 3-D antibody model created using an embodiment of the integrated molecular viewer.

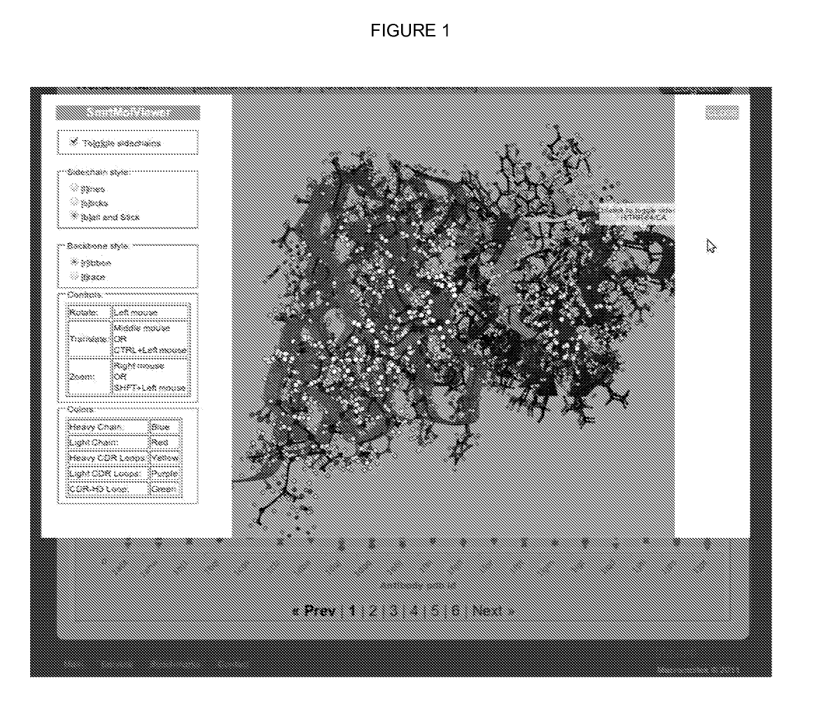

FIG. 2 shows a flowchart of the overall algorithm for antibody modeling using SmrtMolAntibody.

### DETAILED DESCRIPTION OF ILLUSTRATIVE EMBODIMENTS

The present disclosure relates to a comprehensive design of molecular modeling, bioinformatics, and antibody analysis integrated into a single online workspace for antibody modeling and analysis. The disclosed design allows for users to upload an antibody sequence or structure into a workspace that can be stored in an online database. The uploaded sequences or structures may then be selected by the user and multiple functions may be performed including, but not limited to, the following: sequence analysis, structure analysis, antibody modeling, packing, antibody humanization, mutations, design, loop modeling, protein-protein docking, and scoring.

In one embodiment, the Sequence Analysis may be performed through a method of incorporation of known software packages to perform extensive computations of user data. Any previously designed software packages, such as BLAST, are open-source and may be employed using internal calls to the external package. A given sequence entered by a user may be compared against all sequences in a database containing all proteins, all proteins with structures, all antibody proteins with structures, or all human antibody proteins with structures. Once a comparison is complete and an optimal match is returned to the user, the match may be added to the workspace.

In another embodiment, the Structure Analysis may utilize well-known or published algorithms. In this embodiment, protein structures may be stored in a specific and universal format that can be referred to as the Protein Data Bank (pdb) file format. Each stored protein may be identified by a chain letter, with each residue identified by a number, and each atom by yet another number. A structure uploaded can be modified in a number of ways. Some modifications may consist of:
Renaming the chain to a new letter identifier
Renumbering the residues of a protein in the file starting from the number “1,” or a user specified starting number, and continuing sequentially to the end of the protein
Renumbering the atoms of a protein in the file starting from the number “1,” or a user specified starting number, and continuing sequentially to the end of the protein
Identifying any missing atoms in the file (either backbone, non-backbone heavy atoms, or hydrogens) and incorporate them, along with their proper coordinates, into the resulting file

The above listing may be altered or expanded to include other useful modifications.

In some embodiments of Antibody Modeling, the disclosed subject matter may utilize an algorithm that identifies structures with similar sequences to pieces of the desired antibody and assembles a model for the full antibody structure. The sequence identification and assembly may be broken into three or more stages including, but not limited to: 1) assembly of the overall structure, or β barrel; 2) grafting of the five non-H3 CDR loops onto the assembled β barrel; and 3) de novo modeling of the CDR-H3 loop.

When an x-ray crystal structure is not available for a target antibody sequence, the first step may be to create an accurate comparative model of the antibody through homology modeling. Homology modeling may allow the target sequence to be aligned and modeled using a template structure. Antibody homology modeling may be more manageable than general homology modeling of other proteins because antibodies are unique in that they share a common IgG fold and there exist well-established rules for antibody modeling.

An antibody is composed of two heavy chains and two light chains with a total of 12 subdomains arranged in a Y-shape. The antigen binding surfaces are at the ends of the antibody at the tips of the Y and at the interface of the heavy and light chains. The terminal heavy and light domains at each interface are known as the Fv region, compromised of the domains V_{H} and V_{L}. Three loops on each chain comprise the key complementarity determining regions (CDRs) (L1, L2, and L3 on the light chain and H1, H2, and H3 on the heavy chain) that recognize various antigens. For docking analysis, the Fv coordinates are sufficient for epitope mapping. The CDR H3 loop is the most variable region of the antibody and there are no canonical conformations of this loop that can be used for homology modeling. Therefore, the CDR H3 is the area with the most uncertainty in building homology models of the antibody and the loop must be shaped explicitly using template-independent loop modeling techniques.

In one embodiment, Packing may utilize proprietary algorithms for sidechain packing. The specific orientation of the sidechains, or non-backbone atoms, of a protein must be optimized to provide a high resolution structure that can be used for further analysis, such as humanization and/or epitope mapping. Sidechain packing refers to the process of optimizing the coordinates of the sidechain atoms of the protein.

The total energy function during pack and grow has two terms:

Eₜₒₜₐₗ=wᵣₒₜEᵣₒₜ+w_{LJ}E_{LJ}

where Eᵣₒₜ is the rotamer frequency term and E_{LJ} is a modified 6-12 Lennard-Jones (LJ) potential. In some embodiments, the weights wᵣₒₜ=0.5 and w_{LJ}=1.0 were optimized against a small set of high resolution PDB structures. During the initial cycle of packing, the energy function may be adjusted so that the sidechain atoms are set to their most probable conformation by setting wᵣₒₜ=1.0 and w_{LJ}=0.0. The potential functions for the energy terms may be taken from known sources in the field with slight modifications and are described below.

The rotamer frequency term is backbone-dependent and takes the form:

$${E}_{rot} = - {\sum }_{m = 1}^{N} γlog \frac{p ( {R}_{m} \vert {φ}_{m} , {ϕ}_{m} , {A}_{m} )}{p ( {R}_{m} = 1 \vert {φ}_{m} , {ϕ}_{m} , {A}_{m} )}$$

where γ is 2 for big, aromatic amino acids, 0 for Ala and Gly, and 1 otherwise.

In some embodiments of the Packing function, for each residue, p(Rₘ/Φₘ, Φₘ, Aₘ) is the probability of the selected rotamer at a given backbone φ and ψ torsion angle and p(Rₘ=1/Φₘ, φₘ, Aₘ) is the most likely probability at the given backbone torsion angle. The scaling factor γ allows for aromatic amino acids to contribute more total energy. The rotamer frequencies may be derived from the 2002 backbone-dependent Dunbrack rotamer library.

The Lennard-Jones potential term is similar to what is reported in known literature for a potential function between two atoms, i and j. The potential is split into three portions: a linear portion representing repulsion at close distances, the standard 6-12 potential with a multiplier to ensure continuity, and the standard 6-12 potential for the remaining distance. To speed up calculations, the LJ cutoff distance between two atoms is set to d=2.5 Å.

The Lennard-Jones potential may be modified specifically for packing by only calculating the energy between the backbone-sidechain and sidechain-sidechain atoms of two residues and including a self-energy calculation (backbone-sidechain atoms of a given residue). This differs from common implementations that exclude the self-energy and also include backbone-backbone atoms between residues.

Some embodiments of the pack and grow algorithm may consist of several iterations of the sequential packing algorithm that is describe herein. For each iteration of the packing algorithm, the residues may be ordered sequentially from N to C. Starting at the first residue, the sidechain coordinates can be optimized by iterating through each possible rotamer from the Dunbrack backbone-dependent 2002 set and selecting the one with the lowest energy (as determined using the energy function described above). The energy may be calculated after the coordinates of the residue of interest have been updated to the current rotamer conformation and is the sum of the self energy and the energy of the residue of interest and each of its neighbors. Neighbors are all residues within 8 Å of the residue of interest.

In some embodiments of the Packing function, the sidechain groups may be first introduced by assigning the coordinates of the sidechain atoms based on CHarMM chi torsion angles with fixed bond lengths and angles. An initial iteration of the packing algorithm can be used with the modified rotamer potential-only version of the energy function to set the sidechain atoms to the most probable conformations as an initial guess.

After the initial rotamer potential-only iteration of some embodiments of the Packing algorithm, packing may be repeated about five times with scaled sidechains. At the start of each iteration, the sidechains are reduced by reassigning the sidechain atom coordinates to the new locations calculated by scaling sidechain bond values by a factor of λ. The λ factor increases each iteration by 0.1 starting from 0.6 until 1.0 is reached (0.6, 0.7, 0.8, 0.9, and 1.0). Once the sidechain atoms have been rescaled, some embodiments of the Packing algorithm proceed as described above.

In some embodiments of the Antibody Humanization function, a non-human (for example, a mouse) sequence of an antibody is taken and modified to closely resemble a human sequence, while still retaining the desired activity. The non-human sequence may be humanized to prevent the antibody from eliciting an immune response when injected into a human patient.

The process of the Antibody Humanization computational may involve iteratively performing sequence and structural analysis on the sequence of interest. Initially, the non-human sequence may be compared to a database of human sequences to find a close match. Using only sequence information, the important activity-inducing portions of the non-human sequence can be copied into the human sequence. Next, MMTAntibody may be used to create a three-dimensional structure of the antibody. The structure is used to find further mutations near the active regions of the antibody that can help retain activity and stability of the final antibody.

In one embodiment, the Mutation function may be utilized to predict the stability and functional changes in a protein upon mutation, helping to design new proteins and improve existing proteins for specific functions. Mutating a residue computationally may involve changing the type of amino acid at a given position, optimizing the sidechain conformation, and evaluating the change in energy that occurs from the mutation.

Antibodies have a common architecture of a β-barrel shape with six surface loops interacting with an antigen at the epitope. In some embodiments of the Loop modeling function, for sufficiently high sequence identity, the β-barrel framework can be compared against known structures to yield a high-quality sequence alignment, thus making it straightforward to build a good homology model of the overall fold. However, the loop regions may vary considerably, especially the CDR H3 loop, and can be much more difficult to model. Since these surface loops are essential to predicting and improving activity of an antibody, refinement of the loop region is an important aspect of antibody modeling.

During epitope mapping, determining the relative conformation between the three-dimensional structures of an antibody and antigen is an essential step in predicting where the epitope can be found. In some embodiments of the protein-protein docking function, the process of finding the correct conformation is achieved using protein-protein docking algorithms that search the translational and rotational conformational space between two (or more) proteins. Many protein-protein docking algorithms exist that are able to find the docked conformation of multiple proteins when enough biochemical information is available. When there is little or no biochemical information to guide the docking process and provide a relative starting conformation, the number of false positive conformations increases dramatically. For epitope mapping, it is rare to have sufficient biochemical information to create a high-quality structure of the antibody-antigen complex. Therefore, improved algorithms for this problem are essential for epitope mapping.

In some embodiments of the Scoring function, published algorithms and datasets may be employed to identify a correct structure from among many faulty structures. The embodied scoring function may be used for calculating the interactions of the atoms with each other and their environment.

The software in the present disclosure may be accessed using a web browser as the interface for user interaction. Some interfaces employ an integrated viewer for displaying three-dimensional models of complex molecules, such as proteins. Three-dimensional visualization of complex molecules has traditionally been accomplished using desktop software with very few solutions for embedding anything beyond a static image into a web browser. One technique used to view these complex molecules through a web browser, on a web page, is using Java applets or other plugins, which require users to download and install supporting software.

In one embodiment, Three-dimensional Viewing through a web browser may be performed using an integrated molecular viewer developed using web languages, including, but not limited to, HTML5, css, and javascript. This integrated viewer allows users to view the complex molecules in an interactive fashion instead of as a static image. The molecular viewer allows users to view, rotate, and scale molecules in different renderings. Atoms that are bonded may be represented by the lines connecting the atoms in said bonds.

For complex biomolecules, such as proteins, there is an element beyond three-dimensional visualization of the atom points and bond lines. Traces of the overall structure of such biomolecules are rendered using splines to show connections. The three-dimensional effects are achieved through lighting and coloring, as well as the ability to rotate and view changes in the aspects and renderings.

One embodiment of the present disclosure includes a method for an ANTIBODY DATABASE CREATION: A local database of known antibody structures is capable of being created by comparing a consensus sequence of an antibody against the pdbaa database of protein structures (http://dunbrack.fccc.edu/Guoli/culledpdb/pdbaa.tar.gz) using a local copy of BLAST (Altschul, S F., et al, “Basic local alignment search tool.” J. Mol. Biol. 1990; 215:403-410) with the options: -e 1 -M BLOSUM62 -W 2 -m 9 -v 10000-b 10000. The resulting, non-redundant, antibody pdb files are then able to be downloaded and kept in a database. The database is able to be updated regularly to keep current with new structures as they are released. In addition to the database of complete antibody structures, a database for each of the CDR loops is able to be created by extracting the loop regions, plus five residues on either side of the loop, and storing in separate database for each of the L1, L2, L3, H1, H2, and H3 loops.

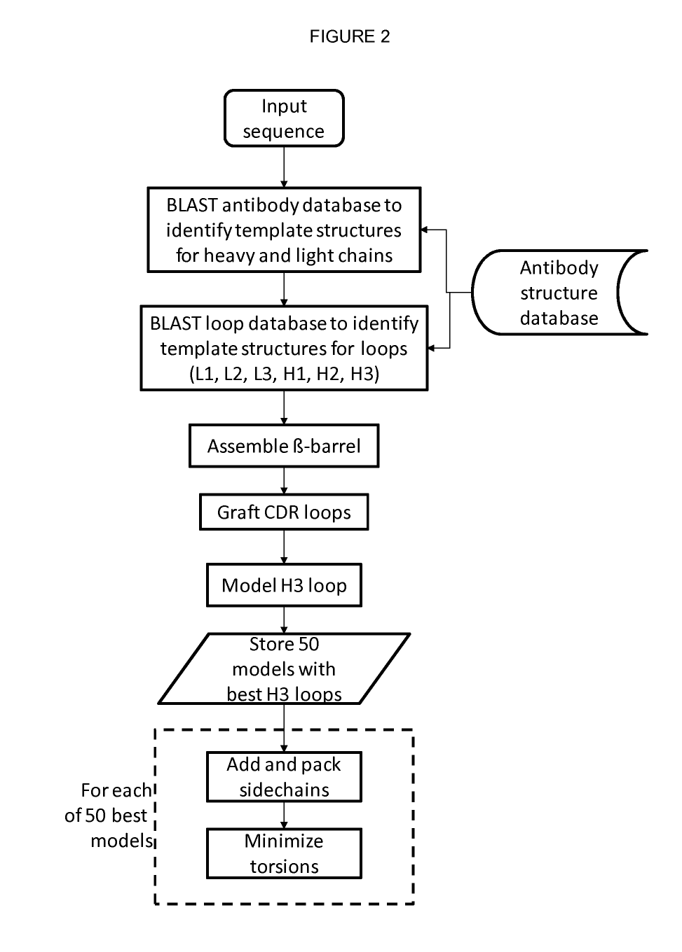

One embodiment of the present disclosure includes an OVERALL PROTOCOL method: FIG. 2 shows the flowchart for the steps used by SmrtMolAntibody to create a structure of an antibody from its individual sequence. The modeling can be done using the structural representation of a protein of SmrtMol software in which all atom distance and angles are able to be described using ideal CHarMM bond lengths and angles. These distances and angles are kept fixed and the torsion angles are allowed to move. In one embodiment, the steps are as follows:
Identify CDR and framework regions from the input sequence using AHo numbering scheme (Honegger, A. and Pluckthun, A., “Yet Another Numbering Scheme for Immunoglobulin variable Domains: An Automatic Modeling and Analysis Tool.” J. Mol. Biol. 2001; 309:6570670) to identify the relevant regions.
Select template PDB structures for the heavy and light chain framework regions from the antibody database described above.
Select template PDB structures for the loops (L1, L2, L3, H1, H2, and H3) using the loop database described above.
Thread the input query sequence for the framework regions of the heavy and light chains onto the template PDB structure coordinates. The template PDB for the light chain is aligned onto the threaded heavy chain using the template light chain's heavy chain to set the orientation of the light/heavy chains.
Graft the non-H3 CDR loops (L1, L2, L3, H1, H2) onto the scaffold using structural alignment of the backbone atoms of the five flanking residues on either side of the loop.
Model the H3 loop (later described in more detail, in the subsequent paragraphs).
Add and pack sidechains for the entire antibody protein.
Minimize sidechain and backbone torsions to relieve any clashes in the structure.

One embodiment of the present disclosure includes a method for the ASSEMBLY OF β-BARREL: The β-barrel describes the conformation of the heavy and light chain of an antibody and the orientation between the two chains. The β-barrel can be assembled by using BLAST to identify the best template structure for each of the heavy and light chains. The input query sequence of the heavy chain is then threaded onto the template structure. In most cases, the template structure of the light chain also contains a heavy chain, which is used to align onto the threaded heavy chain to set the orientation between the two chains. In the absence of a heavy chain in the light chain template structure, the heavy chain template is used to align against the threaded light chain. The loop regions are not threaded, resulting in a structure with no coordinates in the loop regions.

One embodiment of the present disclosure includes a method for the GRAFTING OF NON-CDR LOOPS: Each of the non-H3 CDR loops are able to be grafted onto the scaffold created as described above. The five flanking residues for each of the loops can be used to align and superpose the loop onto the scaffold. Since the alignment is not exact because of differences between the loop template and the scaffold coordinates, the ends of the loops should be optimized to end up with a continuous chain. This is done using SmrtMol's implementation of Cyclic Coordinate Descent (CCD) loop closure (Canutescu, A A. and Dunbrack R L. “Cyclic coordinate descent: A robotics algorithm for protein loop closure.” Protein Sci. 2003; 12(5):963-972). For the c-terminal loop end, CCD is applied in the forward direction from the midpoint of the loop to the c-terminal end. The same is done in reverse from the midpoint to the n-terminal end.

One embodiment of the present disclosure includes a method for the CDR H3 MODELING FOR SMALL AND LONGER LOOPS: Following Dunbrack's rules for defining kinked and extended loop conformations (North B., Lehmann A., and Dunbrack R L. “A new clustering of antibody CDR loop conformations.” J. Mol. Biol. 2011; 406(2):228-256), the first n-terminal stem residue and the last three c-terminal stem residues are fixed by choosing the (phi, psi, omega) values from a previously defined stem table in the database. These rules can be used to classify the loop as kinked or extended and the stem backbone angles reflect this feature. For longer loops this step is obviated proceeding to the next step.

For the CDR H3 loop proper, a successive dimer insertion can be performed randomly taken from all dimers with exact sequence, where dimer fragments are defined by the double set of backbone dihedral angles (phi, psi, omega) obtained from the corresponding table in the database. Each dimer corresponds to the one given by the sequence. The chosen dimers from H3 loops will capture the dihedral angle preferences of the H3 loop and the steric restraints due to its immediate environment. A motif based filter to avoid non-physical backbone angles is included at the end. It consists of a trimer with unspecified sequence taken from the corresponding Table in the database. The trimer torsions are binned (usually at 40 degrees). If the corresponding angles from the constructed loop do not match any of the bins, the loop is rejected. SIDECHAIN PACKING: (Described in more detail above Packing the sidechains is achieved by trying different rotamers for each of the residues in the loop in a sequential order. The procedure is iterated six times modifying the scales of the sidechain.

One embodiment of the present disclosure includes a method for the TORSION MINIMIZATION: The applied score function is a sum of softened Lennard Jones potentials for non-bonded pairs of atoms. In order to decide which rotamer to keep at each step a Metropolis algorithm for the Lennar-Jones energy score function is implemented. A final refinement of the torsion (chi) angles includes a steepest descent energy minimization.

While the invention has been described with respect to a limited number of embodiments, the specific features of one embodiment should not necessarily be attributed to other embodiments of the invention; however, in some embodiments features could be removed and/or combined with one or more features of the other embodiments to create additional embodiments. No single embodiment is representative of all aspects of the inventions. Moreover, variations and modifications therefrom exist. For example, the invention described herein may comprise other algorithms or pieces. Various steps may also be added to further enhance one or more properties of said pieces. In addition, some embodiments of the methods described herein consist of or consist essentially of the enumerated steps. The claims to be appended later are intended to cover all such variations and modifications as falling within the scope of the invention.

What is claimed is:

1. A method, apparatus, and computer readable medium as described above.
